(19) United States
(12) Patent Application Publication
(10) Pub. No.: US 2009/0199654 A1
(43) Pub. Date: Aug. 13, 2009

(54) Method for operating a magnetic induction flowmeter

(76) Inventors: Dieter Keese, Wahlsburg (DE); Thomas-Fritz Blume, Halle (Saale) (DE)

Correspondence Address: Michael M. Rickin;ABB, Legal Dept. - 4U6, 29801 Euclid Avenue, Wickliffe, OH, 44092-1832, US

(21) Appl. No.: 11/630,909

(22) PCT Filed: Jun. 30, 2005
(86) PCT No.: PCT/EP05/07048

§ 371 Date: Dec. 27, 2006

(30) Foreign Application Priority Data
Jun. 30, 2004 (DE) 10 2004 031 638.4

(51) Int. Cl. G01F 1/58

(52) U.S. Cl. 73/861.11

(57) ABSTRACT

The invention relates to a method for operating an inductive flowmeter according to the preamble of patent claim 1. According to the invention, in order to minimise interfering signals, a receiving signal spectrum of all of the interfering signals is detected as a receiving signal, and the vector product between the receiving signal spectrum and a reference voltage is formed. An inverted Fourier transformation is then carried out and the thus obtained resulting signal is used to determine the flow rate.

The invention relates to a method for operating a magnetic inductive flowmeter in which method an electromagnetic signal is brought via electrodes into the measuring medium and the received signal dependent on the flow is recorded via sensors and the flow is thereby determined, according to the preamble of claim 1.

This makes use of the known measurement principle that is applied for magnetic inductive flowmeters. The physical effect exploited for measuring the velocity of flow is the law of induction. If an electrically conductive measurement material is guided through a magnetic field B, then an electrical field E arises in the measurement material perpendicular to the flow direction V and to the direction of the magnetic field. The relationship is E=B×V.

Magnetic induction flowmeters are used for measuring the flow of all liquids, slurries and pastes with a specific minimum electrical conductivity. It can happen here that as a result of non-homogeneous conductivity distribution in the measurement material, or of friction or other chemical or physical influences, the measured test signal is overlaid by interference signals. These interference signals can be many times greater than the test signal, and impair the quality of the flow measurement to the extent that no useful measuring result can be formed.

The invention is therefore based on the object of improving a method of this type such that the interference signals are minimized.

The specified object is achieved for a method of this type according to the invention by the characterizing features of claim 1.

Further advantageous developments of the method according to the invention are specified in the dependent claims.

The basis of the method according to the invention is that as received signal a received signal spectrum including all interference signals is recorded and a vector product is formed between the received signal spectrum and a reference voltage, and subsequently an inverse Fourier transformation is executed and the resulting signal thus obtained is used for determining the flow. This method according to the invention proves in practice to be enormously effective and above all easily executable.

In a further advantageous development it is specified that the associated reference voltage i.e. the drive voltage is sinusoidal.

In a further advantageous development it is specified that a Fourier spectrum, by means of which the low-frequency disturbances can be represented, is already created from the received signal.

In a further advantageous development it is specified that the method is fed with parameters for the mathematical operations, which are stored in a data characteristic field, adaptively and adjusted to individual measuring tasks.

The method according to the invention is shown and explained with the help of the drawn representations.

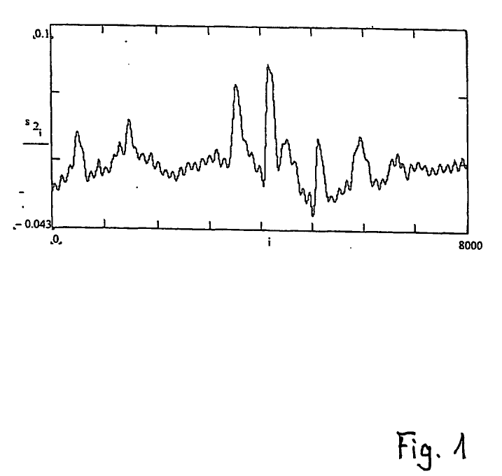

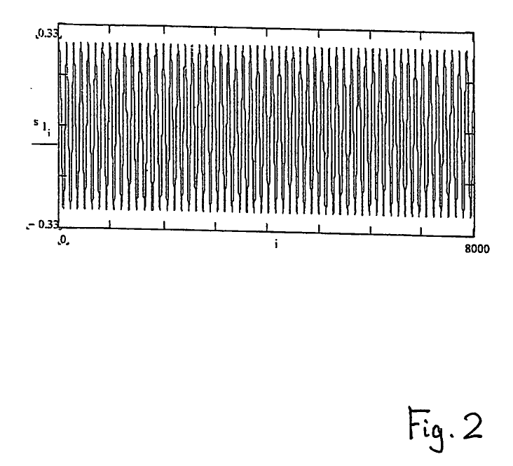

FIGS. 1 to 6 show spectra which help to illustrate it.

FIG. 1 shows the received signal which is a typical useful signal S2 overlaid with interferences. The associated reference voltage corresponds to the drive voltage and should be sinusoidal, the type of excitation being of no importance. Figure shows a Fourier spectrum of the received signal S2, where marked disturbances can be seen in the low-frequency range, and the useful signal itself is e.g. at 70 Hertz.

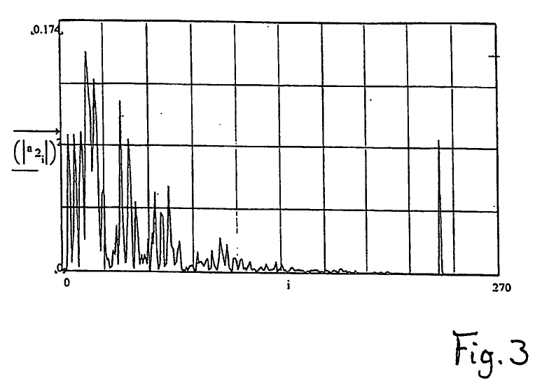

FIG. 3 here the Fourier spectrum can be seen, this being the Fourier spectrum of the reference voltage, containing a signal with a frequency that corresponds to the excitation, in this case e.g. 70 Hertz.

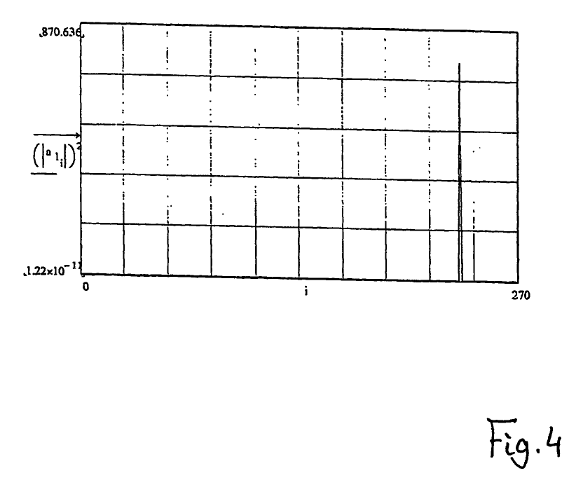

FIG. 4 shows that the conjugate complex spectrum is created from the reference signal. This is already the editing of the signal, i.e. of the received signal with the aim of reducing interference. This yields as reference voltage

Ref. voltage=a1

For filtering, the vector product is formed between the reference voltage and the received signal spectrum a2:

Sa1=Ref. voltage×a2

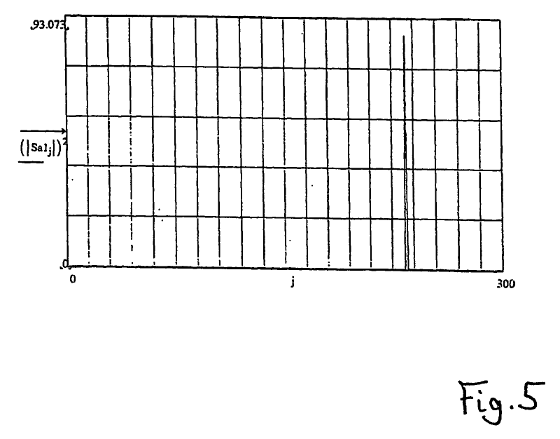

The spectrum thus obtained reflects the relationship between the reference voltage and the received signal spectrum a2. FIG. 5 shows here that in the spectrum there is only a similarity with the reference signal. The received signal then received from inverse Fourier transformation contains only the useful signal components

Sa1 with the frequency of the reference voltage signal

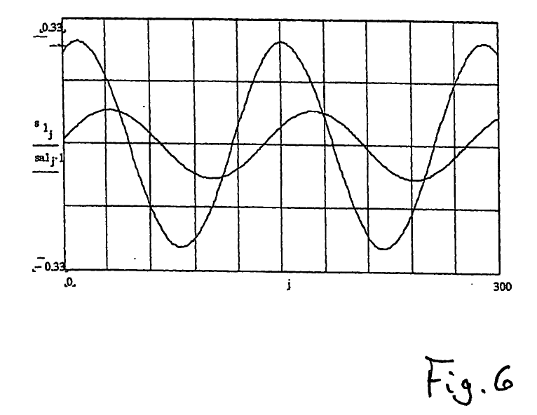

The last representation, i.e. FIG. 6, shows the reference voltage and the filtered signal

In the further signal processing, the relationship to the flow rate is then derived without interference.

1-4. (canceled)

5. A method for operating an inductive flowmeter comprising:
receiving a signal dependent on the flow of a flowing measuring medium in said flowmeter, said received signal including interference signals;
recording from said received signal a received signal spectrum that includes said included interference signals;
forming a vector product between said received signal spectrum and a reference voltage; and
executing an inverse Fourier transformation of said vector product to obtain a signal that does not include said interference signals for use in determining said flow of said flowing measuring medium in said flowmeter.

6. The method of claim 5 wherein said reference voltage is a sinusoidal voltage.

7. The method of claim 5 further comprising creating a Fourier spectrum of said received signal to represent low frequency disturbances in said received signal.

8. The method of claim 6 further comprising creating a Fourier spectrum of said received signal to represent low frequency disturbances in said received signal.
